(19) United States
(12) Patent Application Publication
(10) Pub. No.: US 2012/0232983 A1
(43) Pub. Date: Sep. 13, 2012

(54) METHOD AND APPARATUS FOR PROVIDING DYNAMICALLY OPTIMIZED INCENTIVES

(75) Inventors: Brian Bertha, Danville, CA (US); Stan Kachnowski, Tarrytown, NY (US); Margaret Griffin, New York, NY (US); Ilene Hollin, New York, NY (US)

(73) Assignee: McKesson Speciality Arizona Inc.

(21) Appl. No.: 13/046,023

(22) Filed: Mar. 11, 2011

(51) Int. Cl. G06Q 30/00

(52) U.S. Cl. 705/14.35; 705/14.1

(57) ABSTRACT

A method for providing improved patient medication adherence may include receiving an indication of a current prescription based on claims data associated with a location at which the current prescription is fillable, generating an incentive for a patient associated with the current prescription, and providing the incentive to the patient via an electronically generated message. The incentive may be associated with a product available at the location. A corresponding apparatus is also provided.

### TECHNOLOGICAL FIELD

Embodiments of the present invention relate generally to health care management solutions and, more particularly, relate to the provision of a mechanism by which to improve medication adherence for patients by providing dynamically optimized incentives such as coupons.

### BACKGROUND

Healthcare costs are a hot topic in the media and general population. Both government entities and business entities are focusing on ways to manage healthcare costs to improve affordability and access, and to reduce waste. Thus, in many cases, healthcare related service providers are looking for ways to improve patient care and organizational management by, for example, streamlining their own information management and internal processes. Some of these streamlining efforts have been facilitated or even rely on the use of computers given that there is a push to enable many healthcare management related tasks to be handled by computers. However, the overall success of any healthcare plan also relies largely on creating and reinforcing positive behaviors by various particpants (e.g. patients, physicians, care givers, etc.). Thus, efforts to influence positive change are often dependent upon behavior, which may be outside of the direct control of healthcare service providers.

Many efforts to influence positive change involve sending messages or reminders to patients, providers and other particpants in a one-size-fits-all mentality. However, the effects of these types of messages may not be clear and therefore, their value may not be determinable. Accordingly, it may be desirable to provide a mechanism by which to improve the intended behaviors expected of the recipient.

### BRIEF SUMMARY

A method, apparatus and computer program product are therefore provided to enable the provision of improved medication adherence by using dynamically optimized incentives such as coupons. Accordingly, for example, some embodiments may provide for the use of incentives (e.g., coupons) to entice or otherwise influence patients to pick up medications (and then hopefully also take those medications) after they have been prescribed. Some example embodiments may rely on claims data or other longitudinal healthcare data to determine prescription related events and dynamically generate incentives to be sent to remote patients (e.g., via mobile devices belonging to the respective patients). The incentives generated may be generated based on claims data or other longitudinal healthcare data such that they expire in a time period that is likely to induce the patient to pick up the medications within a time period that fits with the regimen prescribed to the patient.

In one exemplary embodiment, a method for providing improved patient medication adherence is provided. The method may include receiving an indication of a current prescription based on claims data associated with a location at which the current prescription is fillable, generating an incentive for a patient associated with the current prescription, and providing the incentive to the patient via an electronically generated message. The incentive may be associated with a product available at the location.

In another exemplary embodiment, a computer program product for providing improved patient medication adherence is provided. The computer program product may include at least one computer-readable storage medium having computer-executable program code instructions stored therein. The computer-executable program code instructions may include program code instructions for receiving an indication of a current prescription based on claims data associated with a location at which the current prescription is fillable, generating an incentive for a patient associated with the current prescription, and providing the incentive to the patient via an electronically generated message. The incentive may be associated with a product available at the location.

In another exemplary embodiment, an apparatus for providing improved patient medication adherence is provided. The apparatus may include processing circuitry. The processing circuitry may be configured for receiving an indication of a current prescription based on claims data associated with a location at which the current prescription is fillable, generating an incentive for a patient associated with the current prescription, and providing the incentive to the patient via an electronically generated message. The incentive may be associated with a product available at the location.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing improved patient medication adherence with dynamic incentives according to an exemplary embodiment of the present invention;

FIG. 2 is a block diagram showing various components that may be included in an apparatus for providing improved patient medication adherence with dynamic incentives according to an exemplary embodiment of the present invention; and

FIG. 3 is a block diagram according to a method for providing improved patient medication adherence with dynamic incentives according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to improve engagement with patients for medication adherence. Some example embodiments may support the provision of a pharmacy intervention program that may employ a collection of business intelligence and outreach tools to facilitate contact with patients in a manner that is likely to improve medication adherence. In some embodiments, algorithms for identifying patients that are to be contacted under the pharmacy intervention program use a claims edit process. As such, for example, claims data (which refers herein to claims or dispensing data) may be analyzed longitudinally in a master patient index in order to identify patients for the pharmacy intervention program. Some example embodiments may further enable the use of automated contact mechanisms in order to contact the patients themselves and professionals that can interact with the patients to help improve medication adherence.

Failures in medication adherence can be very costly to the health care industry. Failure to take medications in accordance with instructions may obviously cause wastage with respect to medications not taken or not taken in a manner that is likely to be effective. However, the costs of failures in medication adherence also extends to cover the costs of complications that arise from failure to adhere and/or the costs of recurrence or lingering of illness and the subsequent treatments that may continue or even expand. In some cases, failures in medication adherence can be traced to a failure to even pick up a prescription that has been received, and sometimes even filled, at a pharmacy and is waiting for the patient to come in to pick up the prescription. Thus, claims data generated by the pharmacy may indicate that a prescription has been received by the pharmacy and perhaps also filled. If the patient fails to arrive to pick up the prescription, and therefore abandons the prescription, this wastage may be a direct cost that could be avoided if an enticement could be provided to induce the patient to pick up the prescription. Moreover, more indirect costs (e.g., complications from not taking the medication or exacerbation of the patient's condition) may be avoided as well since it is more likely that the patient will take a medication that the patient has already gone through the effort of acquiring.

Other activities that may cause the medication adherence to improve can also be implemented once the patient arrives at the pharmacy, such as counseling the patient on how to take the medication or other instruction that may improve comprehension of the treatment regimen and compliance therewith. However, these activities may also not be able to be employed unless the prerequisite condition of having the patient go to the pharmacy to pick up the medication is met. Thus, inducing the patient to get to the pharmacy to pick up a prescription can be a useful step in relation to improving medication adherence.

Some example embodiments may therefore provide inducements or enticements to attempt to increase the likelihood that the patient will go to pick up prescribed medication. In this regard, some example embodiments may provide for dynamic generation of coupons or other enticements that are time limited in their applicability. The generation of the enticements may be triggered based on claims data and may be location and time sensitive. As such, the enticements may be applicable at a location where the prescription can be picked up and within a time that is limited. The time limitations may be based on a number of factors aimed at enticing or inducing the patient to action. Accordingly, some examples of the present invention may utilize claims data to determine situations where an enticement can advantageously be provided to ultimately improve medication adherence and reduce overall healthcare costs.

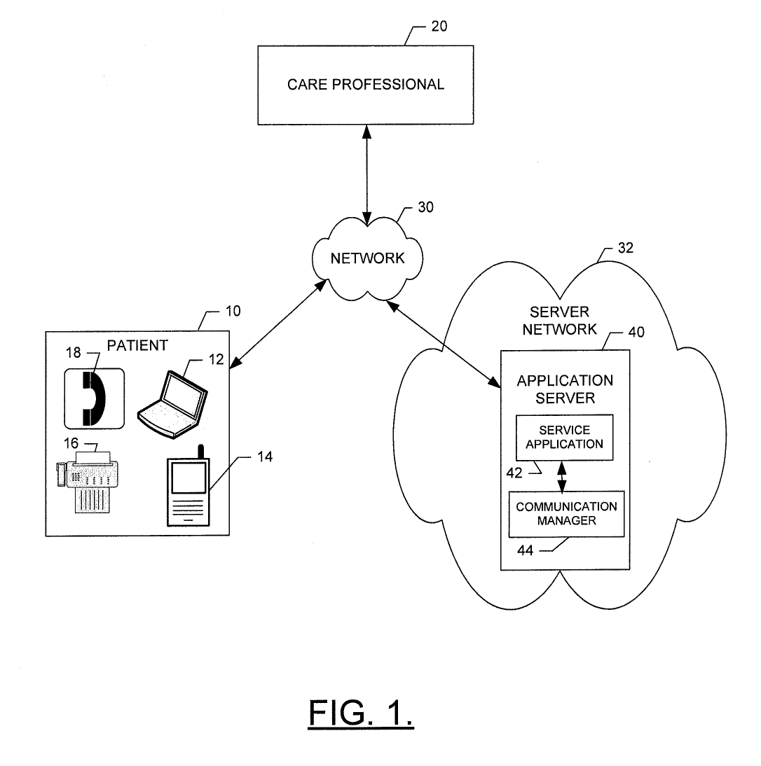

An example embodiment will now be described in reference to FIG. 1, which illustrates an exemplary system in which an embodiment of the present invention may be employed. Of note, the example of FIG. 1 is provided to illustrate several, but not all examples of devices and system architectures that may employ example embodiments. Thus, some examples may include more or less components than those which are shown in FIG. 1. As shown in FIG. 1, a system according to an exemplary embodiment may include one or more patients (e.g., patient 10) that may, in some cases, be reachable via various different modes of communication. For example, the patient 10 may have a personal computer (PC) or laptop computer 12 via which email messages or other multimedia messages may be received. Alternatively or additionally, the patient 10 may have a mobile telephone, personal digital assistant or other mobile communication device 14 that may receive phone calls, text messages, emails or other communications. The patient 10 may also or alternatively be reachable by fax machine 16 or via landline telephone 18. As such, with respect to phone calls and various types of electronic messaging, the patient 10 may generally be reachable by sending messages over a network 30.

The network 30 may be a data network, such as a local area network (LAN), a metropolitan area network (MAN), a wide area network (WAN) (e.g., the Internet), and/or the like. However, in some cases, the network 30 may be a wired or wireless telephone network. As such, communication between the network 30, the patients and the other devices or databases (e.g., servers) to which the network 30 may be coupled can be accomplished by either wireline or wireless communication mechanisms and corresponding protocols.

In some embodiments, the network 30 may also be connected to, or be capable of providing a connection to, a care professional 20 such as a doctor's office, hospital, pharmacy, insurance provider, care manager, or other healthcare related service professional. The care professional 20 may also have access to one or more of the modes of communication described above. The care professional 20 may also be associated with one or more different communication devices that may be used to contact the care professional 20 in connection with example embodiments and/or provide information to the care professional 20 about one or more patients.

In an exemplary embodiment, devices to which the network 30 may be coupled may include one or more application servers (e.g., application server 40), which may form respective elements of a server network 32. Although the application server 40 is referred to as a “server”, this does not necessarily imply that it is embodied on a single device. As such, for example, a server may include a server bank or multiple servers. Moreover, a server could simply be a computer or other computing device acting in a server capacity with respect to the provision of a service to another device (e.g., a communication device of the patient 10 or the care professional 20) without being a blade server including rack units and/or the like. The application server 40 may include hardware and/or software for configuring the application server 40 to perform various functions. As such, for example, the application server 40 may include processing logic and memory enabling the application server 40 to access and/or execute stored computer readable instructions for performing various functions. In an exemplary embodiment, one function that may be provided by the application server 40 may be the provision of any of a plurality of services with respect to the patient 10 and/or the care professional 20. As such, in various exemplary embodiments, certain operations and functionalities described herein in relation to the provision of targeted messaging for improved patient adherence may be fully implemented at one device, or may be implemented in a distributed fashion with different activities being shared between multiple devices. In some examples, the application server 40 may include a service application 42 comprising stored instructions for processing and/or accessing information and providing such information to various communication devices according to a specified mode of communication or providing data generated based on the processing of the information to various communication devices according to a specified mode of communication. For example, the service application 42 may be capable of directing generation of an enticement (e.g., a coupon) to be sent (e.g., via email, fax or text message) to the patient 10 according via a specified mode of communication based on contact information associated with the patient 10.

In an example embodiment, the application server 40 may also host a communication manager 44 configured to determine specific modes of communication and communication parameters for use in contacting the patient 10 to improve medication adherence according to an example embodiment. As such, the communication manager 44 may utilize specific information about the patient 10 (and perhaps also a plurality of other patients) as determined via a claims edit process in order to identify patients that have had prescriptions forming the subject of claims associated with the care professional 20 (e.g., a pharmacist or at least personnel associated with a pharmacy). Moreover, in some cases, the prescriptions may not yet have been picked up by the patient 10. After selection of a mode of communication, the patient (e.g., patient 10) may be contacted according to provide the patient with an enticement or incentive to go to the care professional 20 (e.g., go to the pharmacy) to pick up the prescription.

In some embodiments, the communication manager 44 may be configured to employ a candidate identifier 46 to select candidates for receiving the incentive based on claims data associated with a prescription provided to, received at and/or filled at the pharmacy, but not yet picked up. The communication manager 44 may also be configured to employ an incentive generator 48 to generate (or select from predetermined alternatives) incentives with time and location parameters selected to motivate a selected candidate to go to the location where the prescription can be picked up. After candidate selection and incentive generation (or selection), the communication manager 44 may be configured to select a communication plan (e.g., based on actor characteristics and/or other related information) to implement via the service application 42 for executing sending emails, sending text messages, sending faxes or other electronic communications to the patient 10 to deliver the incentive. In an example embodiment, the candidate identifier 46 may also be configured to generate the incentive based on longitudinal healthcare information regarding the patient 10. As such, the candidate identifier 46 may be configured to tailor a particular incentive to a particular candidate based on healthcare related information that is known about the particular candidate. As indicated above, the incentive generator may be configured to select location parameters and time parameters to bound applicability of the incentive in order to get the patient 10 to pick up the prescription by a certain time, and perhaps also at a certain location.

In some embodiments, rather than being hosted by a server, the communication manager 44 may be hosted by a PC or other computer associated with an organization engaged in healthcare related service provision. Thus, in some cases, the communication manager 44 could even be hosted at a computer associated with the care professional 20. However, in some embodiments, the communication manager 44 may be associated with a third party providing a service associated with facilitating operation of a program for improving medication adherence using time sensitive incentives or enticements such as coupons.

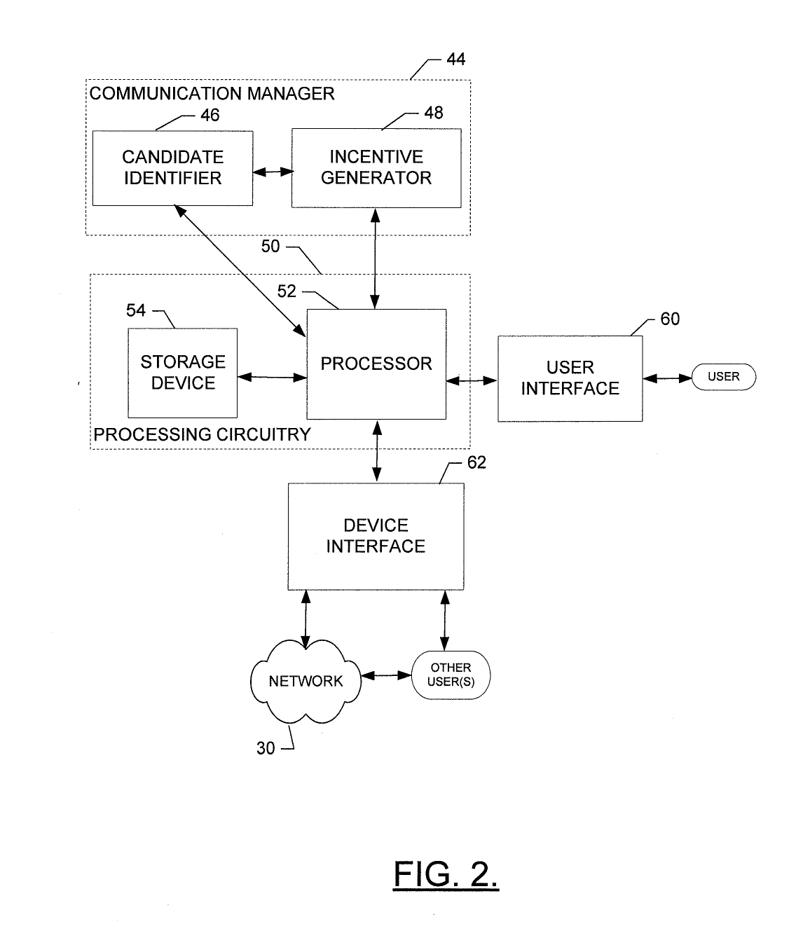

An exemplary embodiment of the invention will now be described with reference to FIG. 2. FIG. 2 shows certain elements of an apparatus for facilitating improved medication adherence using incentives according to an exemplary embodiment. The apparatus of FIG. 2 may be employed, for example, on any of a variety of communication devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients distributed through the network 30). Furthermore, it should be noted that the devices or elements described below may not be mandatory and thus some may be omitted in certain embodiments.

Referring now to FIG. 2, an apparatus for facilitating improved medication adherence is provided. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, and/or other input/output mechanisms. In an exemplary embodiment in which the apparatus is embodied as a server (e.g., the application server 40) or some other network devices, the user interface 60 may be fully implemented, limited, remotely located or eliminated.

The device interface 62 may include one or more interface mechanisms for enabling communication with other devices and/or networks. In some cases, the device interface 62 may be any means such as a device or circuitry embodied in either hardware, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an exemplary embodiment, the storage device 54 may include one or more non-transitory memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases that may store a variety of files, contents or data sets. Among the contents of the storage device 54, applications (e.g., service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control the communication manager 44. The communication manager 44 may be configured to access information from various sources and utilize the information to select a communication plan for sending targeted messaging for improved patient adherence to a patient. The communication plan may define the communication channel or mechanism to be used to communicate with the patient, and may access stored contact information associated with the patient to contact the patient accordingly. In some cases, the communication plan may define a preferred contact method for each respective patient, or may default to predefined methods if no preferences are provided. For example, if the patient has provided information supportive of only one contact method (e.g., only providing an email address), then the corresponding contact method may obviously be employed. However, if the patient has provided information supportive of multiple contact methods (e.g., email, phone number, fax number, etc.), then a preferred or default one of the multiple contact methods may be selected for provision of a message including an incentive to the patient as described in greater detail below. In an example embodiment, the communication manager 44 may include or otherwise communicate with the candidate identifier 46 and/or the incentive generator 48 as indicated above.

The candidate identifier 46 and the incentive generator 48 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the candidate identifier 46 and the incentive generator 48, respectively, as described herein.

The candidate identifier 46 may be configured to apply a set of logic rules to data corresponding to claims data (e.g., from claims that pharmacies enter when prescriptions are received and/or filled and may then be submitted to payers) to determine whether to offer a patient an incentive to go to the pharmacy to pick up a prescription. In an example embodiment, the candidate identifier 46 may be configured to select patients for receipt of an incentive (e.g., a mobile coupon) based on longitudinal healthcare data regarding the patient. The longitudinal healthcare data may be received from an electronic medical record (EMR) of the patient or from other data known about the patient from available sources, or from information provided by the patient. The longitudinal healthcare data may be indicative of the condition (or conditions) for which the patient is being treated. In some cases, the longitudinal healthcare data may include claims data, which may indicate that a current prescription is associated with the corresponding patient and/or past prescriptions of the patient. Since the longitudinal healthcare data may indicate either or both of a current prescription of the patient (e.g., the prescription to which the incentive to go to the pharmacy directly applies) and past prescriptions or healthcare related issues of the patient, the candidate identifier 46 may determine patients that have a current need to pick up a prescription and may also determine potential factors that may impact the patient's likelihood of picking up the prescription. The candidate identifier 46 may then determine whether the patient is a good candidate for sending one or more incentives (e.g., coupons) to the patient in relation to the known current or past needs of the patient. However, in some cases, the selection or generation of the actual incentive may be accomplished by the incentive generator 48 based also on the longitudinal healthcare data. Thus, the incentive may be directly related to the prescription that the patient is being incentivized to pick up (e.g., a coupon for savings on picking up the current prescription), indirectly related (e.g., a general coupon for use in the store or chain associated with the pharmacy to which the prescription was sent) or unrelated (e.g., a coupon for a specific product other than the current prescription such as commonly used over the counter items, or other medications that the patient has used in the past). As such, incentives provided to the patient may be general in nature, or may be selected to be specific to the patient (e.g., based on the patient's past history) based on the longitudinal healthcare data.

According to an example embodiment, the claims data may be the triggering event to cause the candidate identifier 46 to select a patient as a candidate to receive an incentive. For example, when claims data indicates (based on the logic rules) that a particular patient is a good candidate for an incentive, the candidate identifier 46 will select the candidate and inform the incentive generator 48 so the incentive generator 48 can generate a corresponding incentive. In some cases, a determination (e.g., made by the candidate identifier 46) that a patient is a good candidate for receipt of an incentive may be made based on past claims data. For example, if past patient performance indicates that a particular patient is reliable in picking up prescriptions within a predefined period (e.g., within a time limit for expiration of the prescription or within a time limit for reimbursement to be received), then the particular patient may not be a good candidate for receiving an incentive, and no incentive may be sent. However, if past patient performance indicates that the particular patient neglects to pick up prescriptions with some frequency, the patient may be a good candidate for receiving an incentive. In some cases, patients may voluntarily request to receive incentives by enrolling in a program or service for providing incentives. For voluntary participants, incentives may be sent regardless of the impact that sending incentives has on the corresponding participants. Thus, the candidate identifier 46 may, in some embodiments, merely store a list of voluntary participants that may be given incentives when claims data indicates that a prescription has been written for one or more of the participants.

The incentive generator 48 may be configured to select or generate the incentive to be offered. In some cases, past patient performance may indicate positive responses to incentives in general (e.g., improved performance when an incentive is used) or even positive responses to certain types of incentives (e.g., directly related, indirectly related or specific unrelated incentives), the incentives that generate best results for a particular patient may be selected. Moreover, the incentive generator 48 may have access to statistical data indicating likely rates of response and costs for specific different incentives and select an incentive to balance cost versus performance on a patient by patient basis. In some examples, the incentive generator 48 may be configured to randomly select incentives that are available, or to select incentives from partner organizations, brands, or product manufacturers that offer discounts for their products via the incentives sent to motivate patients to pick up prescriptions, or to select incentives that have shown positive past results for a particular patient or for a patient class (e.g., same age, illness, region, etc.) having similar characteristics to the particular patient. The incentive generator 48 may select from predefined message formats and/or coupon formats to generate an incentive that is tailored to the patient and provided the incentive via a message (e.g., via email, SMS, fax, etc.) according to the communication plan selected by the communication manager 44.

In some embodiments, the incentive may be provided in a time sensitive manner in order to induce action by the patient within a specified period of time. Time parameters may be determined by the incentive generator 48 and inserted into any incentive to be sent. The time parameters may be defined according to a time limit for expiration of the prescription or according to a time limit for reimbursement to be received on a claim. The time parameters may define an expiration time for the incentive in order to give the patient the impression that some benefit may be achieved if action is taken by a certain time. The incentives may also be selected to be time relevant. For example, incentives that are directly related to the current prescription are necessarily time relevant since the patient has been prescribed the corresponding medication. However, time relevant incentives may also be selected for unrelated incentives. For example, incentives may be offered on seasonal allergy medications during corresponding periods where such allergies are likely to flare up. Thus, season, temperature, weather and other factors may be considered to determine time relevant incentives that could be offered to selected candidates. In some embodiments, the longitudinal healthcare data or other known information regarding the patient may be used to determine characteristics of the patient (e.g., demographic data or a patient profile), or past purchasing history of the patient. Thus, in some embodiments, the specified or predetermined period of time at which the incentive may expire may be determined based on the intended recipient, the time and/or date of transmission of the incentive, the time and/or date of the pharmacy claim that triggered the transmission of the incentive, recipient past purchasing data, demographic data, profiling models, or the item to which the incentive may be applied.

In an example embodiment, the incentive generator 48 may also be configured to determine location parameters for any incentive to be generated. The location parameters may be selected based on the particular pharmacy (or pharmacy chain) to which the prescription was sent. Thus, the incentives generated may be redeemable only at the corresponding pharmacy (or pharmacies) at which the patient can pick up the prescription to which the claims data that triggered the incentive applies.

In some embodiments, the incentive generator 48 may be configured to include educational content in addition to the incentive. The educational content may include information regarding the product forming the subject of the incentive (e.g., how to use the product, side effect information, potential benefits, test results, or other helpful information regarding the product), information regarding products or practices that may be useful for a certain condition that the patient is known to have, or information regarding products or practices that may be useful for current weather or environmental conditions in the area in which the patient resides.

Accordingly, some example embodiments may provide for an ability to generate incentives that can be sent to motivate patients to go to a location where they can pick up an existing prescription. The incentives are generated based on claims data and may also be generated in the context of longitudinal healthcare data regarding each specific patient to which the incentives are sent. Thus, incentives may be generated that are directly related, indirectly related or even unrelated to the existing or current prescription with the intent of motivating the recipient to go to the location where the prescription can be picked up since the recipient is then more likely to pick up the prescription and use it as directed. Thereby, the recipient's treatment regimen is more likely to be followed and overall healthcare costs may be reduced for the recipient and may be accumulated with cost savings for other recipients to have an appreciable impact on the healthcare system as a whole. The incentive may be provided with location and time parameters that provide bounds over which the incentive is applicable in order to provide enticement for the patient to go to a desired location by a certain time in order to receive the incentive and hopefully also pick up the prescription.

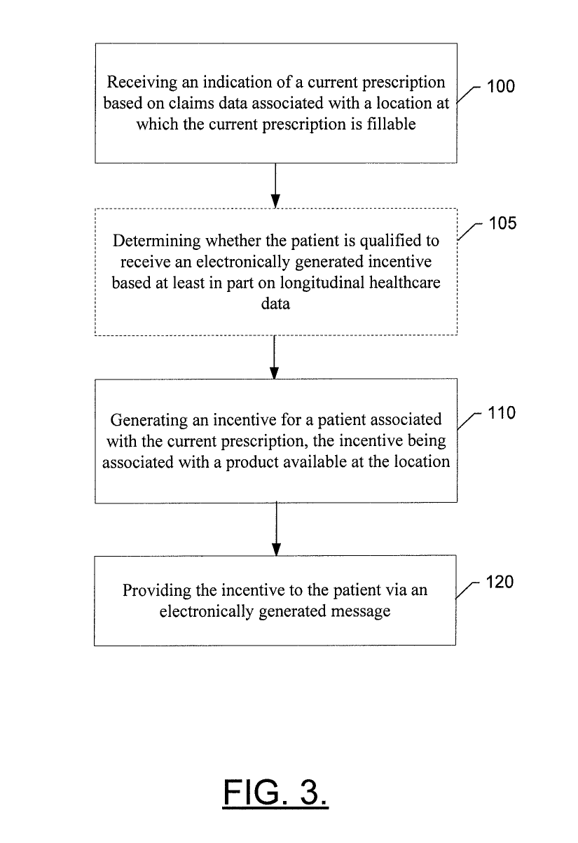

Embodiments of the present invention may therefore be practiced using an apparatus such as the one depicted in FIG. 2 within the overall system depicted in FIG. 1. However, it should be appreciated that some embodiments may be practiced in connection with a computer program product for performing embodiments of the present invention. FIG. 3 is a flowchart of a method and program product according to exemplary embodiments of the invention. Each block of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52). The operations of FIG. 3 may define operations for the execution of an algorithm for improving patient medication adherence. Furthermore, it should be noted that any of the operations of FIG. 3 may be repeated in some embodiments in order to define a cyclical mechanism by which repeated attempts at improving patient behavior in a targeted manner may be implemented. Thus, for example, if a prescription is valid (or reimbursable) over a thirty day period, no incentive may be offered over the first ten days. After ten days a first incentive may be offered (perhaps having a lower value), and then if twenty days is reached a second (and perhaps higher value) incentive may be offered.

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one example embodiment of the invention, as shown in FIG. 3, may include receiving an indication of a current prescription based on claims data associated with a location at which the current prescription is fillable at operation 100 and generating an incentive for a patient associated with the current prescription at operation 110. The incentive may be associated with a product available at the location. The method may further include providing the incentive to the patient via an electronically generated message at operation 120.

In some embodiments, certain ones of the operations above may be modified or further amplified as described below. Moreover, in some embodiments additional optional operations may also be included (some example of which is shown in dashed lines in FIG. 3). It should be appreciated that each of the modifications, optional additions or amplifications below may be included with the operations above either alone or in combination with any others among the features described herein. In some embodiments, the method may further include determining whether the patient is qualified to receive an electronically generated incentive based at least in part on longitudinal healthcare data, wherein generating the incentive comprises generating the incentive responsive to a determination that the patient is qualified at operation 105. In an example embodiment, generating the incentive may include generating a coupon for purchase of the current prescription, generating a coupon for purchase of an item other than the current prescription and/or generating a coupon for use on any product available at the location. In some embodiments, providing the incentive may include providing the incentive as a mobile coupon via an email or a short message service (SMS) message. In some cases, other methodologies may be employed to send the mobile coupon where the coupon is viewed with a software application that is resident on a mobile device and some or all of the data comprising the mobile coupon is transmitted to the mobile device via a secure or encrypted methodology such as, for example, HTTPS. In an example embodiment, generating the incentive may include generating the incentive to expire at a predetermined time. In some cases, generating the incentive to expire at the predetermined time may include generating the incentive to expire at a time selected based on expiration of the current prescription or based on a date beyond which reimbursement will not be made. In an example embodiment, generating the incentive may include selecting the incentive for a product having a correlation to current weather, season or environmental conditions. In some embodiments, the method may further include determining whether the patient is qualified to receive an electronically generated incentive based at least in part on whether the patient is enrolled in a service to receive messages bearing incentives, wherein generating the incentive comprises generating the incentive responsive to a determination that the patient is qualified.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving an indication of a current prescription based on claims data associated with a location at which the current prescription is fillable;
generating an incentive for a patient associated with the current prescription, the incentive being associated with a product available at the location; and
providing the incentive to the patient via an electronically generated message.

2. The method of claim 1, further comprising determining whether the patient is qualified to receive an electronically generated incentive based at least in part on longitudinal healthcare data, wherein generating the incentive comprises generating the incentive responsive to a determination that the patient is qualified.

3. The method of claim 2, wherein generating the incentive comprises generating a coupon for purchase of the current prescription.

4. The method of claim 2, wherein generating the incentive comprises generating a coupon for purchase of an item other than the current prescription.

5. The method of claim 2, wherein generating the incentive comprises generating a coupon for use on any product available at the location.

6. The method of claim 1, wherein providing the incentive comprises providing the incentive as a mobile coupon via an email, a short message service (SMS) message, or a message viewed using a software application resident on a mobile device that employs an encrypted methodology to provide at least a portion of content associated with the mobile coupon.

7. The method of claim 1, wherein generating the incentive comprises generating the incentive to expire at a predetermined time.

8. The method of claim 7, wherein generating the incentive to expire at the predetermined time comprises generating the incentive to expire at a time selected based on information indicative of an intended recipient of the incentive, temporal data associated with transmission of the incentive, temporal data associated with a pharmacy claim triggering transmission of the incentive, past recipient purchasing data, demographic data, patient profile information or the item to which the incentive applies.

9. The method of claim 1, wherein generating the incentive comprises selecting the incentive for a product having a correlation to current weather, season or environmental conditions.

10. The method of claim 1, further comprising determining whether the patient is qualified to receive an electronically generated incentive based at least in part on whether the patient is enrolled in a service to receive messages bearing incentives, wherein generating the incentive comprises generating the incentive responsive to a determination that the patient is qualified.

11. An apparatus comprising processing circuitry configured to:
receive an indication of a current prescription based on claims data associated with a location at which the current prescription is finable;
generate an incentive for a patient associated with the current prescription, the incentive being associated with a product available at the location; and
provide the incentive to the patient via an electronically generated message.

12. The apparatus of claim 11, wherein the processing circuitry is further configured to determine whether the patient is qualified to receive an electronically generated incentive based at least in part on longitudinal healthcare data, wherein generating the incentive comprises generating the incentive responsive to a determination that the patient is qualified.

13. The apparatus of claim 12, wherein the processing circuitry being configured to generate the incentive comprises the processing circuitry being configured to generate a coupon for purchase of the current prescription.

14. The apparatus of claim 12, wherein the processing circuitry being configured to generate the incentive comprises the processing circuitry being configured to generate a coupon for purchase of an item other than the current prescription.

15. The apparatus of claim 12, wherein the processing circuitry being configured to generate the incentive comprises the processing circuitry being configured to generate a coupon for use on any product available at the location.

16. The apparatus of claim 11, wherein the processing circuitry being configured to provide the incentive comprises the processing circuitry being configured to provide the incentive as a mobile coupon via an email, a short message service (SMS) message, or a message viewed using a software application resident on a mobile device that employs an encrypted methodology to provide at least a portion of content associated with the mobile coupon.

17. The apparatus of claim 11, wherein the processing circuitry being configured to generate the incentive comprises the processing circuitry being configured to generate the incentive to expire at a predetermined time.

18. The apparatus of claim 17, wherein the processing circuitry being configured to generate the incentive to expire at the predetermined time comprises the processing circuitry being configured to generate the incentive to expire at a time selected based on information indicative of an intended recipient of the incentive, temporal data associated with transmission of the incentive, temporal data associated with a pharmacy claim triggering transmission of the incentive, past recipient purchasing data, demographic data, patient profile information or the item to which the incentive applies.

19. The apparatus of claim 11, wherein the processing circuitry being configured to generate the incentive comprises the processing circuitry being configured to select the incentive for a product having a correlation to current weather, season or environmental conditions.

20. The apparatus of claim 11, wherein the processing circuitry is further configured to determine whether the patient is qualified to receive an electronically generated incentive based at least in part on whether the patient is enrolled in a service to receive messages bearing incentives, wherein generating the incentive comprises generating the incentive responsive to a determination that the patient is qualified.
